(19) United States
(12) Patent Application Publication
(10) Pub. No.: US 2006/0101330 A1
(43) Pub. Date: May 11, 2006

(54) Browser sitemap viewer

(75) Inventor: Hector Stuart Godley, Hsinchu (TW)

Correspondence Address: HAYNES AND BOONE, LLP, 901 MAIN STREET, SUITE 3100, DALLAS, TX, 75202, US

(73) Assignee: Taiwan Semiconductor Manufacturing Company, Ltd., Hsin-Chu (TW)

(21) Appl. No.: 10/983,553

(22) Filed: Nov. 8, 2004

(51) Int. Cl. G06F 17/24

(52) U.S. Cl. 715/513

(57) ABSTRACT

A sitemap viewer application is provided for use with one or more web browser applications. The sitemap viewer includes a thumbnail image generation mechanism for creating a plurality of thumbnail images from a plurality of web pages. The sitemap viewer also includes a button for use by the web browser application that upon selection, a sitemap window is created for displaying the plurality of thumbnail images. The sitemap viewer utilizes memory for storing an address associated with each thumbnail image. The sitemap viewer activates the corresponding web responsive to a specific thumbnail image being selected.

### BACKGROUND

The present disclosure relates generally to web browsers, and more particularly to an improved browser sitemap viewer.

An example of a web page is a document on the World Wide Web that includes a hypertext markup language (HTML) file with associated files for graphics and scripts in a particular directory and on a particular machine. An example of a web site is a group of related web pages and associated files, scripts, and databases that is served by a server on the World Wide Web. The web pages on the web site generally cover one or more related topics and are interconnected, e.g. through hyperlinks. Many web sites have a home page as their starting point, which frequently functions as a table of contents for the site.

An example of a web browser is a software application that enables a user to view, read, or otherwise access web pages from one or more web sites, as well as files and software related to those web pages. Current web browser applications can blur the distinction between local and remote resources for the user by providing access to documents on a network, an intranet, or a local hard drive. Web browser applications are often built on the concept of hyperlinks, which allows users to point and click with a mouse in order to jump from document to document in whatever order they desire. Many web browser applications are also capable of downloading and transferring files, providing access to newsgroups, displaying graphics embedded in documents, playing audio and video files associated with documents, and executing small programs, such as Java applets or ActiveX controls included by programmers in the documents.

In many computing environments, it may be necessary for users to access multiple web sites or web pages to obtain different types of information. If a user maintains several instances of a browser application (or of different browser applications), a single web page will be “loaded” or readily available on each instance. A locally running operating system will often have a feature by which the different instances are placed or otherwise identified in tab form at the bottom of the computer screen (sometimes called a “tool bar” or “tray”).

Instead of (or in addition to) activating many instances of a browser application, the user may progress the browser application through multiple web pages. The web browser application will likely have one or more features by which the user can potentially return to previously viewed web pages. One feature, referred to as “back” and “forward”, allows the user to return to previously viewed pages in a hierarchical sequence. Another featured, referred to as “history”, lists the web pages accessed in one or more previous sessions.

However, all of these features are relatively cryptic in identifying the previously accessed pages, often using only a few words or addresses to identify the page. Accordingly, it is difficult for a user to properly identify the previously accessed web page. As a result, the user often has to search through multiple pages to return to a particular web page.

Accordingly, it is desirable to provide users with a more effective tool to manage web pages.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a method for providing a browser sitemap viewer according to one embodiment of the present invention.

FIG. 2 is a block diagram of an exemplary system that may be used to implement the browser sitemap viewer method of FIG. 1.

FIGS. 3-8 illustrate exemplary computer screen shots of web browser outputs and sitemap viewers produced by various embodiments of the browser sitemap viewer method of FIG. 1.

### DETAILED DESCRIPTION

It is to be understood that the following disclosure provides many different embodiments, or examples, for implementing different features of the disclosure. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, various ancillary details are provided for the sake of example, and are not intended to limit the invention beyond that which is claimed.

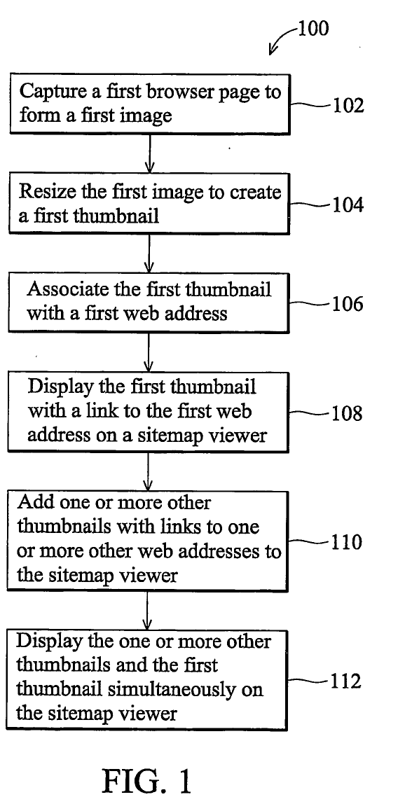

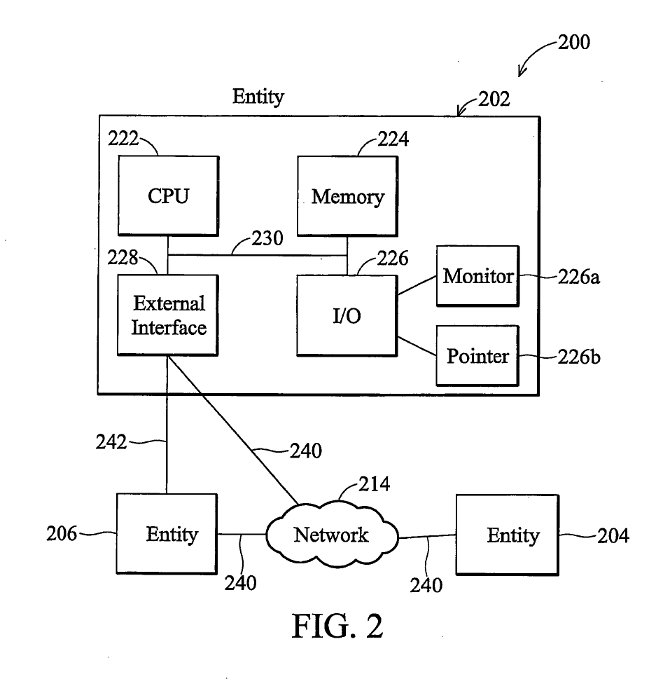

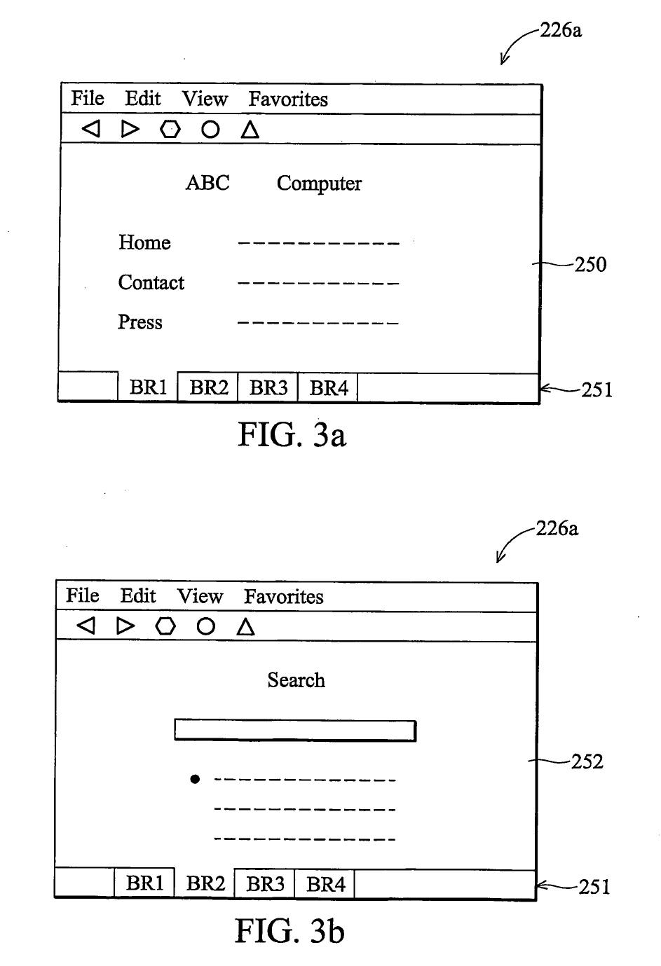

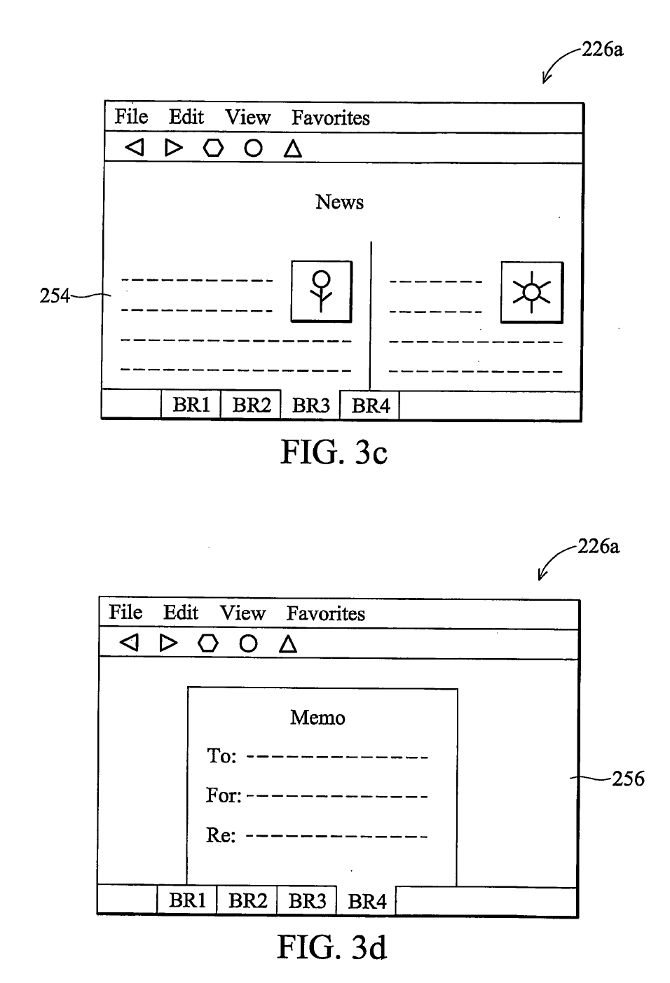

Referring now to FIG. 1, a method 100 can be used for providing a browser sitemap viewer for use with a web browser application. It is understood that the method 100 can be used with other methods and applications. For example, a local memory application for identifying files on one or more attached hard drives can also utilize the method 100. The present method 100 is discussed in general detail below, and then an example computing system and network is described in FIG. 2. Afterwards, several examples of screen shots illustrating the operation of various embodiments of the method 100 are discussed in greater detail with respect to the FIGS. 3-8 of the present disclosure.

The browser sitemap viewer method 100 begins at step 102, where the browser sitemap viewer captures a first web page to form a first image. This can be performed in various manners, such as capturing a bit image of the web page that corresponds to how the web page would be viewed on a monitor or other display device. At step 104 the browser sitemap viewer resizes the first image to create a first thumbnail image. This also can be performed in various manners, such as condensing the bit image to a predefined pixel pattern size by reducing or averaging larger groups of pixels into smaller groups of pixels. At step 106, the browser sitemap viewer associates the first thumbnail image with a first web address. This can be performed by storing the thumbnail image in a memory device such as a table record and including an associated address in the same table record. At step 108, the browser sitemap viewer displays the first thumbnail image on a sitemap window. In some embodiments, the address is also displayed. Although bit map images are generally discussed above, other image types include jpeg, tiff, and so forth. A web browser application will generally have a set of image types that can be readily displayed and a mechanism for generating new windows and/or resizing and moving existing windows. At step 110, the browser sitemap viewer adds one or more other thumbnail images, potentially with links to one or more other web addresses, to the sitemap window. These additional thumbnail images can be obtained as the web browser loads various web pages, or the browser sitemap viewer can communicate with other web running browser applications to obtain the images. A step 112, the browser sitemap viewer displays the one or more other thumbnail images and the first thumbnail image simultaneously on the sitemap window. The browser sitemap viewer may be a software program written C++, C, Java, Java Applet, ActiveX or any other suitable language.

Example System

Referring now to FIG. 2, shown therein is an exemplary computing system 200 that may be used to implement the method 100 of FIG. 1. The computing system 200 includes a plurality of entities represented by one or more entities 202, 204 and 206 that are connected to a network 214. The network 214 may be a single network or a variety of different networks, such as an intranet and the Internet, and may include both wire line and wireless communication channels.

Each of the entities 202, 204 and 206 may include one or more computing devices such as personal computers, personal digital assistants, pagers, cellular telephones, and the like. For the sake of example, the entity 202 is expanded to show a central processing unit (CPU) 222, a memory unit 224, an input/output (I/O) device 226, and an external interface 228. The external interface 228 may be, for example, a modem, a wireless transceiver, and/or one or more network interface cards (NICs). The components 222-228 are interconnected by a bus system 230. It is understood that the entity 202 may be differently configured and that each of the listed components may represent several different components. For example, the CPU 222 may represent a multi-processor or a distributed processing system; the memory unit 224 may include different levels of cache memory, main memory, hard disks, and remote storage locations; and the I/O device 226 may include a monitor 226a, a pointer device (e.g., mouse) 226b, and a keyboard.

In this example, the entity 202 may be connected to the network 214 through a wireless or wired link. The entity 202 may be identified on the network 214 by an address or a combination of addresses, such as a media control access (MAC) address associated with the network interface and an Internet protocol (IP) address. Because the entity 202 may be connected to the network 214, certain components may, at times, be shared with other internal entities. Therefore, a wide range of flexibility is anticipated in the configuration of the entity 202. Furthermore, it is understood that in some implementations, a server may be provided to support multiple internal entities 202. In other implementations, a combination of one or more servers and computers may together represent a single entity.

It is understood that the entities 202, 204 and 206 may be concentrated at a single location or may be distributed, and that some entities may be incorporated into other entities. In addition, each of the entities may be associated with system identification information that allows access to information within the system to be controlled based upon authority levels associated with each entity's identification information. In the present embodiment, the entity 204 is a first server that can communicate with the entity 202 through a network connection 240 through the network 214. The entity 206 is a second server that may communicate with the entity 202 through a more direct connection 242, such as a direct connection or a local network, and/or through the network connection 240. Each of the entities includes an appropriate operating system and may include one or more programs that are based on a variety of languages or programs, such as ActiveX, Wincopy, Java, Java script, C++, Java Applet, and/or other suitable programs. In the present embodiment, the servers 204, 206 also represent web sites and include one or more web pages that can be accessed by the entity 202.

Example Screen Shots

Referring to FIGS. 3a, 3b, 3c, and 3d, for the sake of example, four web browser applications, designated BR1, BR2, BR3, and BR4 are running on the computer 202 (FIG. 2). The web browser applications can be based on commercially available applications, such as Microsoft's Explorer or Netscape's Navigator application. Other applications can be used depending on such factors as an underlying operating system (e.g., a digital assistant operating on a Linux operating system), screen size (e.g., a black and white screen for a cell phone), and so forth. In the present embodiment, only one web browser application can be “active” or currently responsive to user input at a time. This is not intended to be a limitation or requirement of the present invention, but is being used for the sake of example. The four web browser applications BR1, BR2, BR3, and BR4 each produce, among other things, a web page output on the monitor 226a. In FIG. 3a, the web browser application BR1 is active and is displaying a web page 250, which in the present example is a web site for a fictitious company called “ABC Computer.” As can be seen in a tool bar area 251, the letters “BR1” are highlighted, indicating that the web page 250 is active.

In FIG. 3b, the web browser application BR2 is active and is displaying a web page 252, which in the present example is a web site for a search engine. As can be seen in the tool bar area 251, the letters “BR2” are highlighted, indicating that the web page 252 is active. In FIG. 3c, the web browser application BR3 is active and is displaying a web page 254, which in the present example is a web site for a news site. As can be seen in the tool bar area 251, the letters “BR3” are highlighted, indicating that the web page 254 is active. In FIG. 3d, the web browser application BR4 is active and is displaying a web page 256, which in the present example is a word processing document. As can be seen in the tool bar area 251, the letters “BR4” are highlighted, indicating that the web page 256 is active.

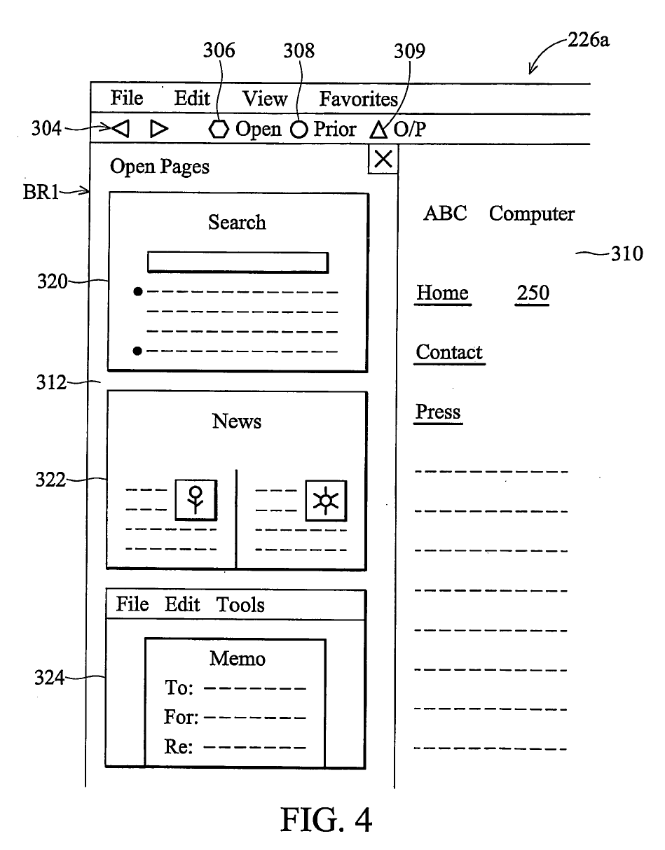

Referring now to FIG. 4, in furtherance of the present example, the web browser application BR1 is active. The web browser application BR1 may include such typical features as back/forward buttons 304. In addition, according to the present embodiment, the web browser application BR1 also includes an “open pages” button 306 and a “prior pages” button 308. The open pages button 306 can be used to quickly view thumbnail images of all the web pages that are currently loaded. The prior pages button 308 can be used to quickly view thumbnail images of previously viewed web pages. It is understood additional buttons may also be provided, including a combination open/prior pages button 309.

In the present example, the open pages button 306 has been selected and the browser sitemap viewer (FIG. 1) has performed several different actions. In one embodiment, the browser sitemap viewer shrinks a main window 310 of the web browser application BR1 used for displaying the web page 250 and adds a sitemap window 312 for showing other currently loaded web pages.

As discussed above with reference to FIG. 1, the browser sitemap viewer obtains thumbnail images 320-324 from a stored location (e.g., memory 224, FIG. 2). The thumbnail images 320-324 are created from the web pages 252, 254, 256 (FIGS. 3b, 3c, 3d), respectively. In one embodiment, the thumbnail images 320-324 are created and stored when the web pages 252, 254, 256 are initially loaded by their respective web browser application (done previously, according to the present example). In another embodiment, the thumbnail images 320-324 are created and stored in response to the user selecting the open pages button 306.

In continuation of the present example, if a user decides to view the web page 254, the thumbnail image 322 can be selected using the pointer device 226b (FIG. 2). In one embodiment, upon selection of the thumbnail image 322, the browser sitemap viewer activates the web browser application BR3 that includes the corresponding web page 254. With this embodiment, the web page 250 remains loaded in web browser application BR1, but the web browser application BR3 becomes active. This embodiment has the benefit of continuing to keep both web pages 250, 254 loaded.

In another embodiment, the present web browser application BR1 continues to be the active application and the web page 254 (which is currently associated with web browser application BR3) is displayed in the window 310. In this embodiment, a new thumbnail image for the web page 250 is placed in the sitemap window 312. In some embodiments, the same web page 254 will now be loaded by both web browser applications BR1 (active) and BR3 (inactive).

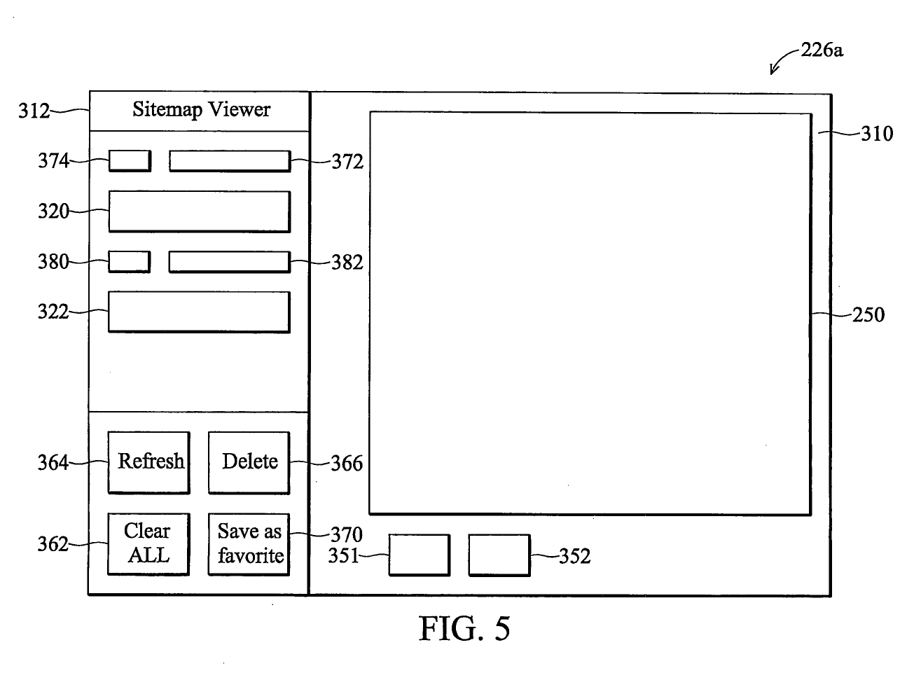

Referring now to FIG. 5, in another embodiment, the sitemap window 312 includes the two thumbnail images 320, 322 and the main window 310 includes the web page 250. The thumbnail image 320 includes an address window 372 and a selection button 374. The thumbnail image 324 includes an address window 382 and a selection button 384. The selection buttons 374, 384 are for identifying the thumbnail images 320, 322, respectively for subsequent operation. For example, the sitemap window 312 includes a Refresh button 364 for refreshing any selected thumbnail image. The sitemap window 312 may also include a Delete button 356 for deleting any selected thumbnail image. A Clear All button 362 may be included for deleting all the thumbnail images (and their associated web addresses and Selection buttons) displayed on the sitemap window 312. Furthermore, a Save as Favorite button 370 may be used to save the web address of a selected thumbnail image in the user's favorite link file. It's contemplated that other optional functions, such as the ability to resize the sitemap window 312 or the thumbnail images 320, 322, may also be added.

Additional features may also be added to the main window 310. In one example, an Add button 351 may be provided so that the sitemap window 312 is only updated with web pages that have been specifically added by the user. Another button, called Auto-Add, can be selected so that the sitemap window 312 is updated with every loaded page. This allows the user to select between a manual (Add button 351) or automatic (Auto-Add button 352) mode of operation.

In another embodiment, the buttons 351, 352 represent folders created to hold thumbnail images of web pages. The folders can be arranged by time, date, or some other user-defined parameter.

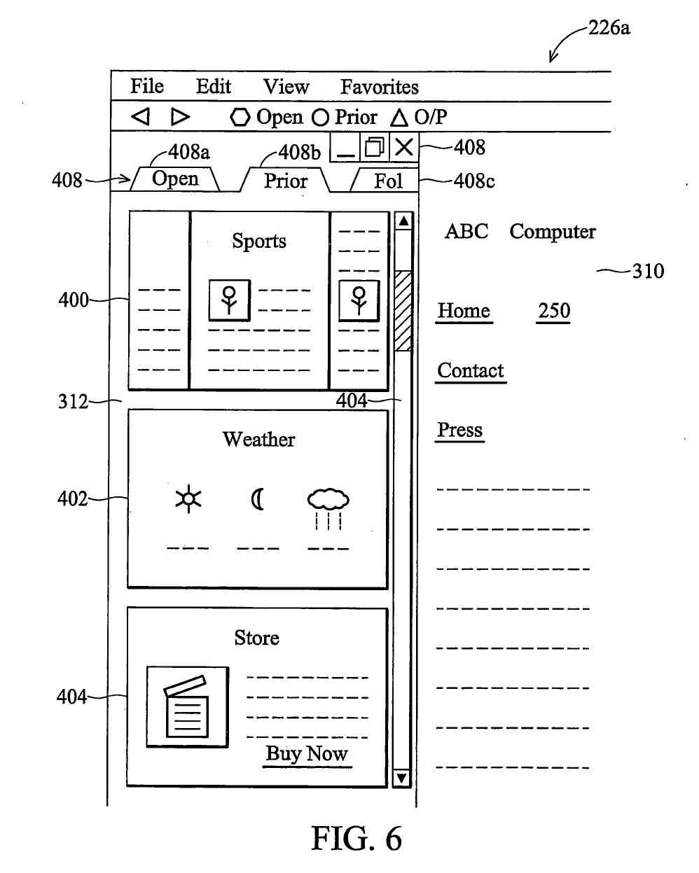

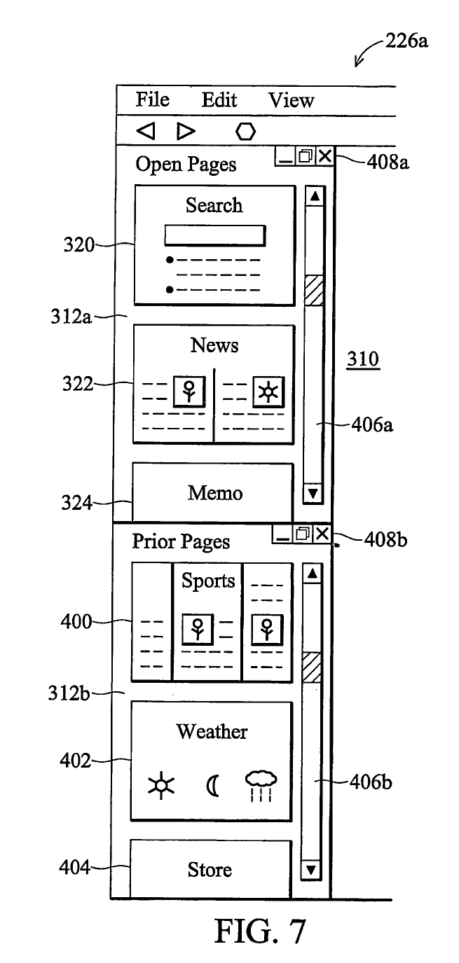

Referring now to FIGS. 6 and 7, the thumbnail images can be provided and arranged in many different ways. In another embodiment, the main window 310 includes the web page 250 but the sitemap window 312 includes thumbnail images 400, 402, 404 of previously viewed web pages. In furtherance of the present example, the browser sitemap viewer 100 (FIG. 1) creates and stores the thumbnail images as the web pages are being loaded (or shortly thereafter). As a result, the listed thumbnail images in the sitemap window 312 includes web pages from all of the visited web sites, and is not limited to maintaining a list in a hierarchical structure (as is currently performed by the back and forward buttons of Microsoft's Explorer). In addition, some embodiments of the browser sitemap viewer may include software for recognizing a previously viewed web page and to prevent loading multiple thumbnail images of the same web page.

Referring specifically to FIG. 6, the present embodiment includes a scroll bar 406 to allow the user to view more thumbnail images images, as desired. Folder tabs 408 are provided to allow a user to quickly switch between viewing thumbnail images of the prior pages and the currently open (loaded) pages, if any exist. Furthermore, additional folders can be created to store pre-arranged thumbnail images. For example, a folder 408a can be used to show all the currently opened pages, a folder 408b can be used to show all the previously visited pages (which may or may not extend beyond the current session of the web browser application BR1), and a folder 408c can be used to show all the visited and/or opened web pages according to a particular identifier. For example, the folder 408c can represent the home page for the ABC Company (as shown in web page 250), and the folder can include a thumbnail image for the home page as well as thumbnail images for any nested pages associated with the home page. The thumbnail images for the nested pages can be derived in response to the web browser BR1 actually viewing the corresponding pages (so that the list may be a subset of all available nested pages), or can be derived automatically to go out and search for all the nested web pages and display thumbnail images accordingly. Also, a minimize/maximize/close button set 408 is provided, as discussed in greater detail below.

Referring specifically to FIG. 7, the sitemap window is split into two sub-windows 312a, 312b and the scroll bar is split into two scroll bars 406a, 406b. Also, two minimize/maximize/close button sets 408a, 408b are provided.

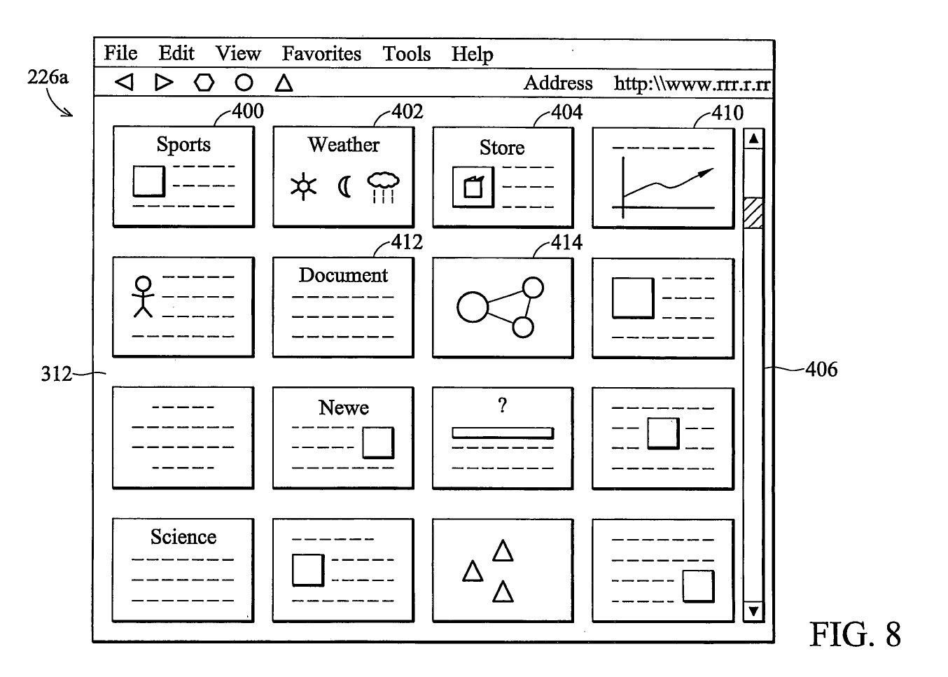

Referring also to FIG. 8, if one of the minimize/maximize/close button sets 408 (FIG. 6) or 408a, 408b (FIG. 7) is selected to maximize the sitemap window 312, more thumbnail images can be viewed on the web browser application. For example, if the minimize/maximize/close button set 408 is selected, the image of FIG. 8 shows that in addition to the three thumbnail images 400, 402, 404, many more thumbnail images can be viewed. Also, the thumbnail images do not have to be web pages from remote websites, but can be images of spread sheets 410, word processing documents 412, presentations 414, and so forth.

If the minimize/maximize/close button set 408 is selected to close the sitemap window 312, the web browser application returns to having only a single web page displayed in the main window 310. Alternatively, if some other sub-window was previously opened, like a “Favorites” window as can be provided by Microsoft's Explorer web browser application, then the favorites window can be restored.

Although only a few exemplary embodiments of this invention have been described in detail above, those skilled in the art will readily appreciate that many modifications are possible in the exemplary embodiments without materially departing from the novel teachings and advantages of this invention. Also, features illustrated and discussed above with respect to some embodiments can be combined with features illustrated and discussed above with respect to other embodiments. Accordingly, all such modifications are intended to be included within the scope of this invention.

I claim:

1. A method for providing a browser sitemap viewer for use with a web browser application, the web browser application for providing a main viewing window for displaying web pages, the method comprising:
creating a first thumbnail image of a first web page, the first web page being different from a displayed web page in the main viewing window;
associating the first thumbnail image with a first address;
displaying the first thumbnail image with a link to the first address on a sitemap viewer window; and
upon receiving a user input identifying the first thumbnail image, instructing the web browser application to display the first web page using the first address.

2. The method of claim 1 further comprising:
repeating the steps of creating, associating, and displaying for a second thumbnail image and a second address for a second web page different from the first web page and the displayed web page.

3. The method of claim 2 wherein the first and second web pages are provided from web sites visited during a single instance of the web browser application.

4. The method of claim 2 wherein the first and second web pages are provided from web sites accessed by two different instances of the web browser application.

5. The method of claim 2 furthering comprising resizing the sitemap viewer window, so that the thumbnail images are displayed in a different format.

6. The method of claim 2 further comprising:
providing a first and second button for selecting the first and second thumbnail image, respectively, from the sitemap viewer window; and
providing a delete button for removing a selected thumbnail image.

7. The method of claim 2 further comprising:
providing a first and second button for selecting the first and second thumbnail image, respectively, from the sitemap viewer window; and
providing a favorites button for adding the address corresponding to a selected thumbnail image to a favorites list of the web browser application.

8. The method of claim 2 further comprising:
providing an add button for allowing a web page being viewed in the main window to have a corresponding thumbnail image be added to the sitemap viewer window.

9. The method of claim 2 further comprising:
organizing web pages with an identical home page in a folder; and
displaying the folder on the sitemap viewer window.

10. The method of claim 2 further comprising:
organizing web pages with a common access date in a folder; and
displaying the folder on the sitemap viewer window.

11. A sitemap viewer application for use with a first web browser application, the sitemap viewer application comprising:
a thumbnail image generation mechanism for creating a plurality of thumbnail images from a plurality of web pages;
a first button for use by the web browser application that upon selection, a sitemap window is created for displaying the plurality of thumbnail images;
a memory device for storing an address associated with each thumbnail image; and
instructions responsive to a specific thumbnail image being selected, for activating the corresponding web page.

12. The sitemap viewer application of claim 11 wherein the corresponding web page is activated by accessing the corresponding address and loading the corresponding web page into a main window of the first web browser application using the accessed address.

13. The sitemap viewer application of claim 11 wherein the corresponding web page is activated by activating a second web browser page that currently has the corresponding web page loaded.

14. The sitemap viewer application of claim 11 wherein the corresponding web page is loaded on a second web browser application and the thumbnail image generation mechanism includes instructions for accessing the second web browser application.

15. The sitemap viewer application of claim 11 further comprising:
a plurality of select buttons for display in the sitemap window, the plurality of select buttons corresponding to the plurality of thumbnail images.

16. The sitemap viewer application of claim 15 further comprising:
a delete button for display in the sitemap window by which selected thumbnail images can be removed from the sitemap window.

17. The sitemap viewer application of claim 11 further comprising:
a plurality of folder images for arranging the plurality of thumbnail images.

18. The sitemap viewer application of claim 11 wherein the thumbnail image generation mechanism includes software for creating the thumbnail images in response to web sites accessed by the first web browser application.

19. The sitemap viewer application of claim 11 wherein the thumbnail image generation mechanism includes software for creating the thumbnail images in response to web sites currently loaded by other web browser applications.

20. The sitemap viewer application of claim 11 wherein the thumbnail image generation mechanism includes software for creating the thumbnail images in response to web sites accessed by the first web browser application as well as web sites currently loaded by other web browser applications.

21. A method for providing a browser sitemap viewer, the method comprising:
creating a current session sitemap viewer wherein the creating comprises:
capturing one or more web pages from a current web session to form one or more images;
resizing the one or more images to create one or more current thumbnail images;
associating the one or more current thumbnail images with one or more web addresses;
organizing the one or more current thumbnail images according to the order by which they were accessed by the user; and
displaying the one or more current thumbnail images with links to the one or more web addresses on the current session sitemap viewer; and
creating a historical sitemap viewer wherein the creating comprises:
capturing one or more web pages from different web sessions to form one or more historical images;
resizing the one or more historical images to create one or more historical thumbnail images;
associating the one or more historical thumbnail images with one or more historical web addresses;
organizing the one or more historical thumbnail images according to the order by which they were accessed by the user; and
displaying the one or more historical thumbnail images with links to the one or more historical web addresses on the historical sitemap viewer.

22. The method of claim 21 wherein all of the thumbnail images may be deleted from the current and historical session sitemap viewers at once.
